(19) United States
(12) Patent Application Publication
(10) Pub. No.: US 2008/0227392 A1
(43) Pub. Date: Sep. 18, 2008

(54) System and Method for Sense-Areas for Ad-Hoc Networking

(75) Inventors: Dennis Van De Meulenhof, Helmond (NL); Nathalie Dorothee Pieternel Leurs, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/585,788

(22) PCT Filed: Jan. 11, 2005
(86) PCT No.: PCT/IB2005/050120

§ 371 Date: Jul. 12, 2006

Related U.S. Application Data
(60) Provisional application No. 60/536,214, filed on Jan. 13, 2004.

(51) Int. Cl. H04B 7/00

(52) U.S. Cl. 455/41.2

(57) ABSTRACT

A method and system are provided for electronic devices (10i, 30i, 40i, 50i, 60i) in a home network to have a sense area (310) for detecting one another. This sense area (310) eliminates participation of outsiders in a home network (100, 300, 400, 500, 600). To allow sense areas that are particular (110) to a given device type, in an alternative embodiment, the size and shape of the particularized (110) sense areas can be made to depend on device characteristics, such as portability, and the sensitivity of the device can be adjusted to meet device requirements. Devices (10i, 30i, 40i, 50i, 60i) are placed near to one another to form a network and if no device is sensed communication and display of one another's user interfaces is optionally disabled so others cannot see the device, e.g., when the device (10i, 30i, 40i, 50i, 60i) is removed from its home network (100, 300, 400, 500, 600).

The present invention relates to sense areas for in-home networking of electronic devices.

All common wireless (802.11x, Bluetooth) standards for in-home networking implement device discovery mechanisms to identify all devices within the network coverage area for communication. Typically, these coverage areas vary from ˜10 meters (e.g., Bluetooth power class original) up to 30 meters (e.g., 802.11a/b/g) whereas in the near future ranges from ˜10 centimeter (e.g., Bluetooth power class short) up to 100 meters (e.g., Bluetooth power class long) are foreseen. Thus, a device will build an overview of all devices within its range (read coverage area). In urban environments this may result in “unwanted” behavior such as a device being recognized by or recognizing devices from neighbors or just passers-by. This “unwanted” behavior for users means a possible privacy issue (becoming visible to others whereas invisibility is preferred) and it means being overwhelmed with all kind of devices that appear on the user interface (UI) of the sensing device since they are within the coverage area of the sensing device.

Most discovery protocols offer a mode of being invisible to others that solves only part of this problem. This “invisibility” also includes a user's own devices, which are possible candidates for ad-hoc networking. Other mechanisms employ “pairing” between trusted devices. Note that this comprises the “unwanted” visibility of one of the devices that is required to initially establish a “pair”. Typically, this mechanism requires user intervention in order to become “visible” and enter a Personal Identifier Number. Note that forming a pair doesn't mean that a device always is within range of communication to its “pair” device.

The present invention provides a system and method for a device sense-area that enables devices with the ability to sense their direct environment in order to discover keys (e.g., containing at least one of device information and user information) of potential devices for communication. One advantage of the present invention is that the user controls when, where and which devices are selected for communication simply by putting these devices in proximity to one another.

Any systems that can be part of an ad-hoc network, ranging from Stationary Consumer Electronic (CE) products (e.g, TV, Disc Systems, Radio) and Mobile CE products (e.g., Phone, Cameras, PDAs, Storage Containers, MP3 players) to Medical Systems (e.g, Portable screens, portable ECGs) are included in the system and method of the present invention.

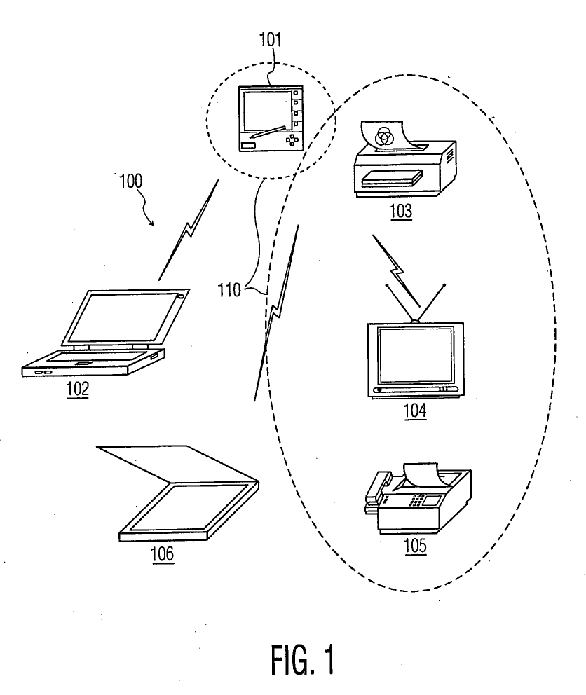

FIG. 1 illustrates a typical in-home set of CE devices whereto embodiments of the present invention are to be applied.

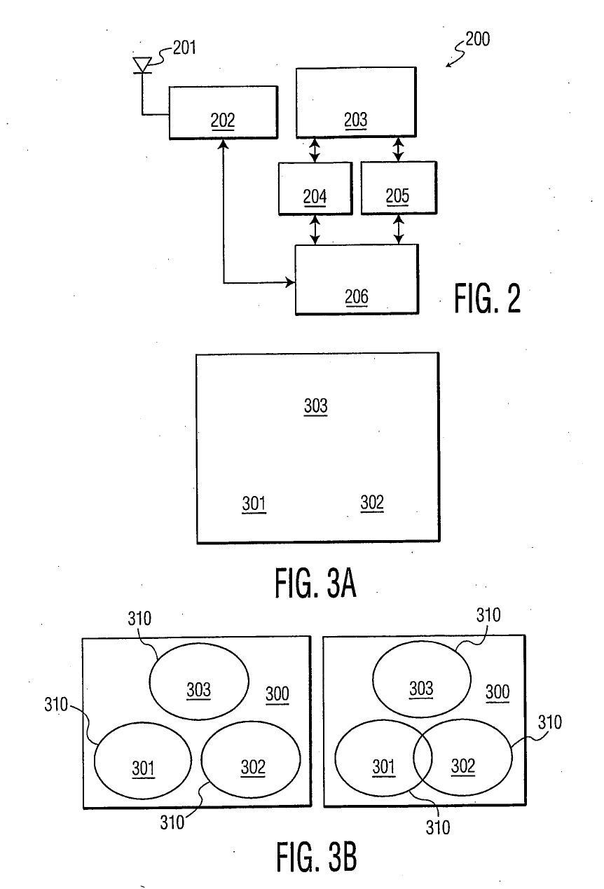

FIG. 2 illustrates an example of hardware that can be used to perform the present invention.

FIGS. 3 A-C illustrate sense-areas for ad-hoc networking of three devices, according to an embodiment of the present invention.

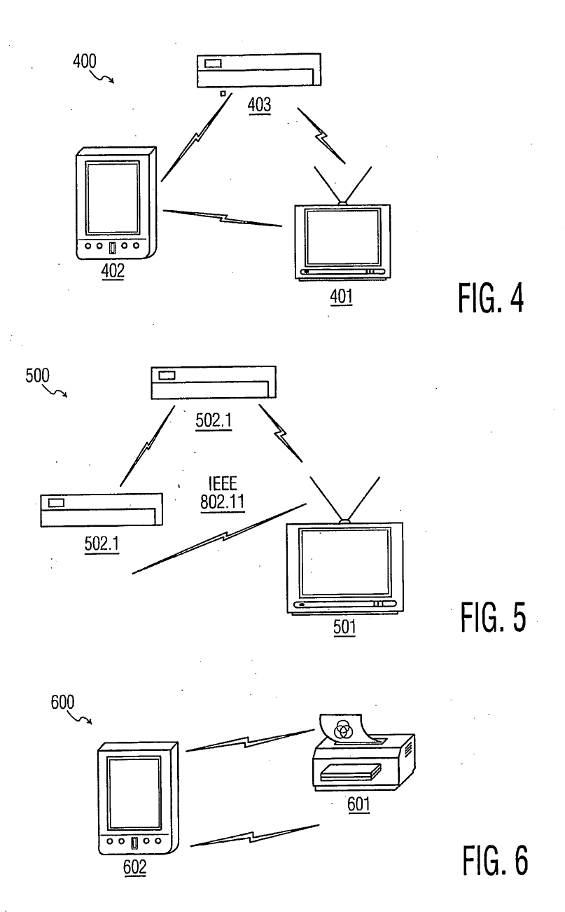

FIG. 4 illustrates a Bluetooth network for displaying images on a TV according to an embodiment of the present invention.

FIG. 5 illustrates an IEEE 802.11 network modified according to an embodiment of the present invention.

FIG. 6 illustrates a Bluetooth network for printing files stored on a portable device according to an embodiment of the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

In this description the word “network” also stands for peer-to-peer communication;

FIG. 1 illustrates a representative in-home set of CE devices which are likely to be networked using an embodiment of the present invention applied to each CE device. As shown in FIG. 1, each CE device is coupled to a plurality of other CE devices, which through a wireless link, are communicating with each other via a plurality of wireless channels. A key principle of the present invention is to provide a sense-area mechanism to limit the visibility of each device to those in close proximity to each device, i.e., to a sense area on the order of 10 centimeters. A preferred embodiment of the present invention provides a fixed sense-area that is less than or equal to 10 centimeters.

However, even though some CE devices are easily moved, e.g., a handheld computer 101, a laptop 102, others are less mobile, e.g., a printer 104, a scanner 106, a television 104 and a fax 105. Therefore, in an alternative preferred embodiment the sense-area of a CE device is sized according to the portability of the CE device it modifies.

Hence, virtually any CE device can be modified with an embodiment of the present invention. Since all CE devices have a greater and lesser degree of portability, in preferred embodiments, different size sensing areas are employed between less portable devices, e.g., a television 104 and a printer 103, to allow flexible placement of these less portable CE devices in a home. In a preferred embodiment, each of the CE devices has at least one of a transmit power and a receive sensitivity that is one of pre-set or can be adjusted for the networking environment in which the CE device participates.

A device modified according to the present invention may include a system with an architecture that is illustrated in the block diagram of FIG. 2. Each CE device may include an antenna 201, a transceiver 202, a detection logic module 203, a memory 204 and a storage 205. The exemplary system 200 of FIG. 2 is for descriptive purposes only. Although the description may refer to terms commonly used in describing particular CE devices, the description and concepts equally apply to other processing systems, including systems having architectures dissimilar to that shown in FIG. 2.

In operation, the transceiver 202 is coupled to the antenna 201 to convert received signals and desired transmit data into corresponding digital data. Through processing of converted received signals by the detection logic module 203, a CE device senses its direct environment in order to discover the keys of potential other CE devices for communication. These discovered keys are stored in the memory 204 by the detection logic module 203. The storage 204 stores the device specific settings, such as transmit power level and receive sensitivity, and other r data such as standard CE device types, capabilities, and corresponding display icons. Updates to the stored data 205 are received via the antenna 201 and transceiver 202 with appropriate control by the update logic module 206. The detection logic module 203, in an alternative embodiment, enables and disables communication and/or use of the other CE device's user interface depending on whether or not it senses other CE devices within its pre-set sense area.

Typically, “sense-areas” are much smaller (˜10 centimeter) than the coverage area of the network, but at a maximum are equal to the network coverage area in, order to be able to guarantee communication. Since CE device keys are only “visible” within such a sense-area, “unwanted” behavior, such as that described above, can be avoided. Therefore, if a user wants two or more devices to participate in a network then the user positions these devices in proximity to each other, thereby enabling them to communicate with one another via a wireless link. In t his way, the user controls when, where and with whom devices may communicate.

Alternative embodiments include enhancement of the “richness” of the key so that a key may comprise device information (e.g., type, capabilities) and/or user information (e.g., authorization keys, finger print information); asymmetrical sensing-areas between devices in a coverage area e.g., by using different transmit-power and/or different receive sensitivity; multiple representations of the devices in a network, e.g. how they are represented in a U′; a CE device only enabling communication if it senses other devices within its sense-area and otherwise disabling communication (becoming invisible) giving the user a valuable sense of control since the user knows how big the sense area is (e.g. 10 cm), so the user is aware of visibility to others.

FIGS. 3A-C show a preferred embodiment of “sense-area for ad-hoc networking” within a coverage area (indicate by the dashed block) of a specific network. The dashed circle 305 indicates the “sense-area” of each device. In the situation depicted in FIG. 3A, the devices 301 302 303 don't have a sense-area and have to fallback to an already known mechanism for discovery at the network level. In the situation illustrated in FIG. 3B, the devices 301 302 303 have a “sense-area” but do not sense each other since they are out-of-range. Therefore, they will not authorize and not communicate (although they might use the discovery at network level since they are in one network coverage area). In the situation illustrated in FIG. 3C, the devices 301 and 302 are in each other's sense-area, so they authorize and start communication. Device 303 does not take part in this communication, Note, that Device 303 may still “hear” all the communication between Device 301 and Device 302. Although the sense areas of FIGS. 3B-C are circular, this is for discussion purposes only, and it is understood by those skilled in the art that the shape of the sense are of a device depends on the antenna used by the device and that the sense areas may be of varying shapes and areas.

### ALTERNATIVE EMBODIMENT 1

Referring now to FIG. 4, suppose a Bluetooth ad-hoc network 400 comprises the following devices: a TV 401, photo camera enabled personal digital assistant (PDA) 402 and a portable hard disk 403. As long as these devices are within 10 meters range of each other they might communicate. To create the “sense-areas”, a short-range sensing technology in the form of a tag (reader) is added to the devices. The coding of the tag is such that the device can be uniquely identified. The tag reader can only read these tags if they are in short range (−10 cm) of each other. To show the pictures stored by the PDA 402 on the TV screen 401, the user only has to put the PDA 402 near the TV 401 and the pictures are shown on the TV 401. Similarly, the portable hard disk 403 can be put near the TV 401 in order to show its audio/video content on the TV 401.

### ALTERNATIVE EMBODIMENT 2

Referring now to FIG. 5, suppose an 802.11 network 500 comprises of the following devices: TV 501 with tag reader and two portable MP3 players 502.1 502.2 each with a tag. If both audio devices 502.1 502.2 are within the sense-area of the TV 501, the UI of the TV automatically generates a playlist that combines all of their music.

### ALTERNATIVE EMBODIMENT 3

Referring now to FIG. 6, suppose a Bluetooth ad-hoc network 600 consists of the following devices: printer 601 with tag reader and photo camera enabled PDA 602 with tag. By bringing the phone 602 near the printer 601, the PDA 602 senses the printer 601. As a result, the phone 602 proposes to print the currently ‘activated’ file (e.g. a selected picture). The user simply accepts and the picture is printed on the printer 601.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to a particular embodiment disclosed as the best mode contemplated for carrying out the present invention, but that the present invention include all embodiments falling within the scope of the appended claims.

What is claimed is:

1. A method for implementing a sense-area (110, 310) of a plurality of devices (10i, 30i, 40i, 50i, 60i) with respect to one another, comprising the steps of:
defining the sense area (110, 310) of a device (10i, 30i, 40i, 50i, 60i) of said plurality as a coverage area having the device (10i, 30i, 40i, 50i, 60i) within said coverage and in which coverage area the device (10i, 30i, 40i, 50i, 60i) is visible to an other device (10i, 30i, 40i, 50i, 60i) of said plurality; and
limiting the visibility of the device (10i, 30i, 40i, 50i, 60i) to the other device (10i, 30i, 40i, 50i, 60i) according to whether or not the other device (10i, 30i, 40i, 50i, 60i) is within said coverage area.

2. The method of claim 1, further comprising the steps of:
detecting the presence of an other device (10i, 30i, 40i, 50i, 60i) according to the presence of a key in a received signal, and
the device (10i, 30i, 40i, 50i, 60i) making itself visible by including a key in a transmitted signal.

3. The method of claim 1, further comprising the step of depending on whether or not an other device (10i, 30i, 40i, 50i, 60i) is detected within the sense area (110, 310), respectively enabling and disabling at least one of communication and use of the other device's user interface.

4. The method of claim 1, wherein the defining step further comprises the step of defining the sense area (110, 310) coverage of each device (10i, 30i, 40i, 50i, 60i) of said plurality as at least one of a predetermined fixed shape and area.

5. The method of claim 4, wherein said predetermined fixed are includes a maximum dimension of less than or equal to 10 cm.

6. The method of claim 1, wherein said defining step further comprises the step of defining the area and shape of said sense area (110, 310) according to a portability characteristic of the device (10i, 30i, 40i, 50i, 60i).

7. The method of claim 6, wherein said are increases in a manner that is inversely proportional to an ease of carrying portability characteristic of the device (10i, 30i, 40i, 50i, 60i) such that the less portable the device (10i, 30i, 40i, 50i, 60i) the larger the area and the more portable the smaller the area.

8. The method of claim 1, further comprising the step of providing each device (10i, 30i, 40i, 50i, 60i) of said plurality with at least one of a transmit power and a receive sensitivity.

9. The method of claim 8, further comprising the step of setting at least one of said transmit power and said receive sensitivity is set to a predetermined fixed value.

10. The method of claim 8, further comprising the steps of:
providing a networking environment in which said plurality of devices (10i, 30i, 40i, 50i, 60i) participate; and
adjusting at least one of said transmit power and said receive sensitivity according to the provided networking environment.

11. The method of claim 10, wherein the networking environment is at least one of Bluetooth short, Bluetooth long, and IEEE 802.11a/b/g.

12. A method for enabling communication between a plurality of devices (10i, 30i, 40i, 50i, 60i) comprising the steps of:
providing each device (10i, 30i, 40i, 50i, 60i) of the plurality with a sense area (110, 310) implemented according to the method of claim 1; and
placing each device (10i, 30i, 40i, 50i, 60i) of the plurality within the provided sense area (110, 310) of every other device.

13. A system that provides a device (10i, 30i, 40i, 50i, 60i) with a sense-area (110, 310) having a shape and size, comprising:
a transceiver 202 coupled to an antenna (201) to transmit and receive signals to and from other devices (10i, 30i, 40i, 50i, 60i) within the sense area;
a detection logic module (203) configured to—
i. detect a device (10i, 30i, 40i, 50i, 60i) within the sense area (110, 310) from a signal received by the transceiver (202); and
ii. transmit a signal via the transceiver (202) to make itself visible to any other device (10i, 30i, 40i, 50i, 60i) within the sense area (110, 310);
a memory (204) coupled to the detection logic module (203) that stores detected device (10i, 30i, 40i, 50i, 60i) information; and
a storage (205) coupled to the detection logic module (203) that provides persistent storage of device-specific (10i, 30i, 40i, 50i, 60i) settings.

14. The system of claim 13, wherein the device-specific (10i, 30i, 40i, 50i, 60i) settings comprise at least one of an area of the sense-area (110, 310), a shape of the sense-area (110, 310), a maximum dimension of the sense-area (110, 310), transmit power level, receive sensitivity, standard device (10i, 30i, 40i, 50i, 60i) types for detection and their capabilities, display icons corresponding to data stored in the storage.

15. The system of claim 13, wherein:
the detection logic module (203) is further configured to—
iii. detect a device (10i, 30i, 40i, 50i, 60i) according to the presence of a key in a received signal, and
iv. make itself visible by including a key in the transmitted signal.

16. The system of claim 13, wherein a maximum dimension of the sense area (110, 310) is a predetermined fixed value.

17. The system of claim 16, wherein said predetermined fixed value is less than or equal to 10 cm.

18. The system of claim 13, wherein said maximum dimension is determined according to a portability characteristic of the device (10i, 30i, 40i, 50i, 60i).

19. The system of claim 18, wherein said portability characteristic is ease of carrying and said maximum dimension varies in a manner that is inversely proportional to said portability characteristic such that the less portable the device (10i, 30i, 40i, 50i, 60i) the larger the maximum dimension and the more portable the smaller the maximum dimension.

20. The system of claim 13, wherein said detection logic module (203) is further configured to control at least one of a transmit power and a receive sensitivity.

21. The system of claim 20, wherein at least one of said transmit power and said receive sensitivity is set to a predetermined fixed value by said detection logic module (203) for the control thereof.

22. The system of claim 20, wherein said detection logic module (203) is further configured to adjust at least one of said transmit power and said receive sensitivity according to a networking environment (100, 300, 400, 500, 600) in which the device (10i, 30i, 40i, 50i, 60i) participates.

23. The system of claim 20, wherein the networking environment (100, 300, 400, 500, 600) is at least one of Bluetooth short, Bluetooth long, and IEEE 802.11 a/b/g.

24. The system of claim 16, wherein the detection logic module (203) is further configured to:
v. depending on whether or not an other device (10i, 30i, 40i, 50i, 60i) is detected within the sense area (110, 310), respectively enable and disable, at least one of communication and use of the other device's (10i, 30i, 40i, 50i, 60i) user interface.
